(19) United States
(12) Patent Application Publication
(10) Pub. No.: US 2012/0042111 A1
(43) Pub. Date: Feb. 16, 2012

(54) BUS BANDWIDTH MONITORING DEVICE AND BUS BANDWIDTH MONITORING METHOD

(75) Inventors: Keisuke Nakazono, Tokyo (JP); Tomonori Yonemoto, Yokohama-shi (JP); Akira Ueno, Tokyo (JP)

(73) Assignee: OLYMPUS CORPORATION, Tokyo (JP)

(21) Appl. No.: 13/209,942

(22) Filed: Aug. 15, 2011

(30) Foreign Application Priority Data
Aug. 16, 2010 (JP) 2010-181611

(51) Int. Cl. G06F 13/14

(52) U.S. Cl. 710/305

(57) ABSTRACT

A bus bandwidth monitoring device may include a buffer unit that is connected to a common bus, the buffer unit storing data that has been input via the common bus, a processing unit that performs predetermined processing based on the data stored in the buffer unit, and a detection unit that detects a bandwidth of the data of the common bus based on a state of storage of the data that is input to the buffer unit through the common bus.

### BACKGROUND OF THE INVENTION

1. Field of the Invention

The present invention relates to a bus bandwidth monitoring device and a bus bandwidth monitoring method.

Priority is claimed on Japanese Patent Application No. 2010-181611, filed Aug. 16, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In many of the system LSIs, for example, system LSIs mounted in image processing devices such as a camera for static images, a camera for dynamic images, an endoscope for medical use, and an endoscope for industrial use, a plurality of built-in processing blocks share a single DRAM (Dynamic Random Access Memory) connected thereto. In such system LSIs, the built-in processing blocks are connected to a data bus inside the system LSI. Each processing block accesses the DRAM through DMA (Direct Memory Access). At this time, a bus controller controls accesses to the DRAM while properly arbitrating requests to access the DRAM from the processing blocks. In the arbitration of the access requests by the bus controller, it is required that the access requests from the processing blocks be arbitrated so as to satisfy the performance as a system.

Methods of arbitrating access requests include the static priority method and the round-robin method. The static priority method is a method in which a static level of priority is preset for every processing block and the access request from the processing block with a higher level of priority is preferentially accepted. In the round-robin method, the processing block whose access request has been accepted is set lower in its level of priority while the processing block whose access request has not been accepted is set higher in its level of priority, thus making the access requests from the processing blocks equally acceptable.

However, the methods of arbitrating access requests such as the static priority method and the round-robin method is not capable of finely set the priority levels of the processing blocks according to, for example, operation modes of the image processing apparatus. For example, Japanese Unexamined Patent Application, First Publication No. H5-61818 discloses a technique of counting the number of times the access request is accepted in every processing block, and then changing the priority levels of the processing blocks based on the count.

With the combination of the static priority method and the round-robin method, for example, Japanese Unexamined Patent Application, First Publication No. 2007-114918 and Japanese Unexamined Patent Application, First Publication No. 2004-178056 discloses a method of dynamically arbitraging access requests in which the priority levels of the processing block are dynamically modified. In the technique disclosed in Japanese Unexamined Patent Application, First Publication No. 2007-114918, the priority levels of the processing blocks are dynamically changed according to the frequency of the access requests sent from the processing blocks such as by making higher the priority levels of the processing blocks whose access request has not been accepted for a predetermined period of time or longer. In the technique disclosed in Japanese Unexamined Patent Application, First Publication No. 2004-178056, priority levels of a plurality of processing blocks are incremented by a predetermined amount when the access requests from the processing blocks conflict one another, to thereby modify the priority levels dynamically.

In a method of arbitrating access requests such as disclosed in Japanese Unexamined Patent Application, First Publication No. H5-61818, the number of access requests of each processing block within a predetermined time for measurement range. Thereby, an average value of the bus bandwidths, which represents data amounts on the data bus when DRAM is accessed by each processing block, (an average bandwidth) is measured. Based on the information on the measured average bandwidth, the priority level of each processing block is changed.

However, in the actual operation of each processing block, there are cases where a variance in frequency of access requests results in a longer processing time or an excessive occupation of the data bus even if the average bandwidth of the data bus is the same.

A relationship among the frequency of an access request, the processing time, and the occupation of a data bus will be described. FIG. 7 schematically shows an exemplary relationship between accesses and processing time of a single processing block. FIG. 7 shows the case of a processing block in which an internal processing is performed for every set of two bus accesses. FIG. 7(a) shows an example in which the grouped bus accesses causes an occupation of access to a DRAM for a certain length of time. FIG. 7(b) shows an example in which the bus accesses to the DRAM is not grouped but dispersed. The measurement result of the average bandwidth of the data bus is the same for the bus accesses shown in FIG. 7(a) and the bus accesses shown in FIG. 7(b). In the case of FIG. 7(a), it is possible to occupy the accesses to the DRAM. However, because data for the subsequent processing is not prepared after completion of the internal processing, the time in which the internal processing is suspended is long, resulting in a long processing time.

FIG. 8 schematically shows an exemplary relationship of accesses of a data bus in two processing blocks. Similarly to FIG. 7, FIG. 8 shows the case of a processing block in which an internal processing is performed for every set of two bus accesses. FIG. 8(a) shows an exemplary relationship between bus accesses and a processing time in the case where buss accesses of a single processing block are made in a grouped manner, similarly to FIG. 7(a). FIG. 8(b) shows an exemplary relationship between bus accesses and a processing time in the case where bus accesses of a single processing block are made in a dispersed manner, similarly to FIG. 7(b). Similarly to FIG. 7, the measurement result of the average bandwidth of the data bus is the same for FIGS. 8(a) and 8(b). In addition, unlike FIGS. 7(a) and 7(b), the processing time of the processing block is the same for FIGS. 8(a) and 8(b).

FIGS. 8(c) and 8(d) show cases where two processing blocks are in simultaneous operation. FIG. 8(c) shows a case where a processing block A, which makes bus accesses in a grouped manner similarly to FIG. 8(a), and a processing block B, which makes bus accesses in a dispersed manner similarly to FIG. 8(b), are in simultaneous operation. FIG. 8(d) shows a case where a processing block A and a processing block B, which make bus accesses in a dispersed manner similarly to FIG. 8(b), are in simultaneous operation.

As is seen from FIGS. 8(c) and 8(d), simultaneous operation of two processing blocks produces a difference in the entire processing time even if the average bandwidth and the processing time are the same in one of the processing blocks, that is, the processing block A. Namely, in FIG. 8(d), two processing blocks are capable of accessing DRAM without interfering each other. On the other hand, in FIG. 8(c), conflicts in the data bus in periods X produce periods of time that prevents the processing block B from accessing the DRAM, resulting in a long, entire processing time. The conflicts in the data bus in the periods X were produced by the occupation of the access to the DRAM by the processing block A when the processing block B is to access the DRAM.

Thus, only by the average bandwidth when the processing blocks use the data bus, it is not possible to judge the performance as a system. Therefore, it is difficult to properly arbitrate the access requests from the processing blocks.

In the techniques of dynamically modifying the priority levels such as disclosed in Japanese Unexamined Patent Application, First Publication No. 2007-114918 and Japanese Unexamined Patent Application, First Publication No. 2004-178056, it is often required to set the priority levels of the processing blocks according to the average bandwidth of the data bus in the access requests sent from the processing blocks, the capacities of the buffers provided in the processing blocks, the importance levels of the processing blocks in each operation mode of the system, and the like, so as not to cause a failure as a system.

However, there is no way to obtain information functioning as a guideline when the priority levels of the processing blocks are set. For example, if there is a failure as a system, there is no way to identify factors such as which processing block has caused the system failure or the degree of modification of the priority settings to allow the system to operate without failure. Therefore, conventionally, in setting the priority levels of the processing blocks, the priority levels are provisionally set and the system is actually operated. With the repetition of this procedure, the settings that do not cause a failure as a system are found. This results in a low efficiency in system development.

### SUMMARY

The present invention provides a bus bandwidth monitoring device and a bus bandwidth monitoring method that are capable of obtaining information useful for setting the priority levels of processing blocks.

A bus bandwidth monitoring device may include a buffer unit that is connected to a common bus, the buffer unit storing data that has been input via the common bus; a processing unit that performs predetermined processing based on the data stored in the buffer unit; and a detection unit that detects a bandwidth of the data of the common bus based on a state of storage of the data that is input to the buffer unit through the common bus.

A bus bandwidth monitoring device may include a processing unit that performs predetermined processing on input data and outputs the processed data; a buffer unit that is connected to a common bus, the buffer unit storing the data that has been output by the processing unit and outputting the stored data to the common bus; and a detection unit that detects a bandwidth of the data on the common bus based on a state of reading of the data that is output to the common bus from the buffer unit.

The detection unit may include a counter unit that measures a period of time between a time when the data is input to the buffer unit from the common bus and a time when the data is stored in all storage area of the buffer unit. Information on the period of time measured by the counter unit may be output as information on the bandwidth of the data on the common bus.

The detection unit may include a counter unit that measures a period of time between a time when the data stored in the buffer unit is output through the common bus and a time when the data is read out from all storage area of the buffer unit. Information on the period of time measured by the counter unit may be output as information on the bandwidth of the data on the common bus.

The detection unit may include a maximum value storage unit that stores information of a maximum period on the periods of time measured by the counter unit; and a minimum value storage unit that stores information of a minimum period on the periods of time measured by the counter unit. The information of a maximum period stored in the maximum value storage unit and the information of a minimum period stored in the minimum value storage unit may be output as pieces of information on the bandwidth of the data on the common bus.

The buffer unit may include a plurality of buffer circuits each of which stores the data. The detection unit may switch the plurality of buffer circuits. The counter unit may measure the periods of time of each of the plurality of buffer circuits. The maximum value storage unit may store information on a maximum period of time out of the periods of time measured by the counter unit. The minimum value storage unit may store information on a minimum period of time out of the periods of time measured by the counter unit. The detection unit may output the information on the maximum period of time stored in the maximum value storage unit and the information on the minimum period of time stored in the minimum value storage unit as information on bandwidth of the data on the common bus.

The buffer unit may include a plurality of buffer circuits each of which stores the data. The counter unit may measure the periods of time of each of the plurality of buffer circuits respectively. The maximum value storage unit may store information on a maximum period of time out of the periods of time measured by the counter unit respectively. The minimum value storage unit may store information on a minimum period of time out of the periods of time measured by the counter unit respectively. The detection unit may output each of the information on the maximum period of time stored in the maximum value storage unit and each of the information on the minimum period of time stored in the minimum value storage unit related to the plurality of buffer circuits as information on bandwidth of the data on the common bus.

A bus bandwidth monitoring method may include steps of storing data that is input through a common bus; performing predetermined processing based on the stored data; and detecting a bandwidth of data on the common bus based on a state of storage of the data input through the common bus.

A bus bandwidth monitoring method may include steps of: performing predetermined processing on input data and outputting the processed data; receiving and storing the output data via a common bus; outputting the stored data to the common bus; and detecting a bandwidth of data on the common bus based on a state of reading of the data output to the common bus.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing a schematic configuration of an image processing device in accordance with a first preferred embodiment of the present invention;

FIG. 2A and FIG. 2B are block diagrams each showing a schematic configuration of a processing block in accordance with the first preferred embodiment of the present invention; FIG. 3A, FIG. 3B, FIG. 4A, and FIG. 4B are diagrams showing a schematic configuration and for explaining a method of obtaining priority guideline information in a processing block in accordance with the first preferred embodiment of the present invention;

FIG. 5 is a block diagram showing a configuration of the bus bandwidth monitoring circuit 137 in the processing blocks in accordance with the first preferred embodiment of the present invention;

FIG. 6 is a diagram for explaining an example of modifying the amount of change by which the priority level of a processing block is changed according to the result (priority guideline information) obtained by the bus bandwidth monitoring circuit in accordance with the first preferred embodiment of the present invention;

FIG. 7 is a diagram schematically showing an exemplary relationship between accesses and processing time of a single processing block;

FIG. 8 is a diagram schematically showing an exemplary relationship of accesses of a data bus in two processing blocks.

### DETAILED DESCRIPTION OF THE PREFERRED EMBODIMENTS

The present invention will be now described herein with reference to illustrative embodiments. Those skilled in the art will recognize that many alternative embodiments can be accomplished using the teaching of the present invention and that the present invention is not limited to the embodiments illustrated for explanatory purpose.

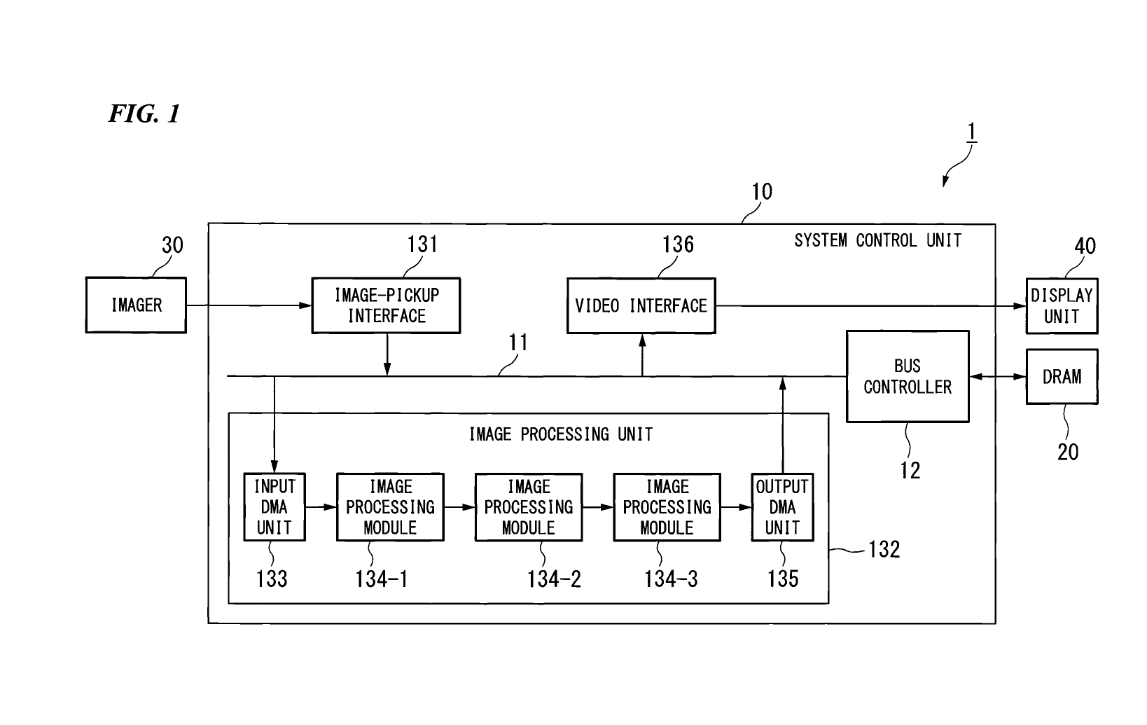

FIG. 1 is a block diagram showing a schematic configuration of an image processing device in accordance with the first preferred embodiment of the present invention. The image processing device 1 shown in FIG. 1 includes: a system control unit 10; a DRAM 20; an imager 30; and a display unit 40.

The imager 30 includes a solid-state image sensing device that photoelectrically converts an optical image of a subject imaged by a lens (not shown in the figure). The imager 30 outputs image signals in accordance with the light of the subject (hereinafter, referred to as “input image data”) to the system control unit 10.

The display unit 40 includes a display device such as an LCD (Liquid Crystal Display). The display unit 40 displays an image based on image signals for display that are output from the system control unit 10 (hereinafter, referred to as “output image data”).

Access to the DRAM 20 is controlled by the system control unit 10. The DRAM 20 stores a variety of data during processing by the system control unit 10.

The system control unit 10 is a system LSI that performs a variety of processing operations in the image processing device 1. The system control unit 10 includes: a bus controller 12; an image-pickup interface 131; an image processing unit 132; and a video interface 136. The constituent elements in the system control unit 10 are connected to one another via a data bus 11, and uses the DMA access to read data from the DRAM 20 and write data to the DRAM 20.

At this time, the bus controller 12 arbitrates DMA access requests to the DRAM 20 that are sent from the constituent elements connected to the data bus 11, and actually accesses the DRAM 20.

When a DMA access request is input from any of the constituent elements in the system control unit 10, the bus controller 12 checks whether there is another constituent element that is currently in use of the data bus 11 to make a DMA access to the DRAM 20. If there is another constituent element that is currently in use of the data bus 11, the bus controller 12 does not accept the DMA access request. If there is no other constituent element that is currently in use of the data bus 11, the bus controller 12 accepts the DMA access request that has been input, and controls the DRAM 20 in accordance with the DMA access by the constituent element that has output the DMA access request.

Furthermore, if DMA access requests are input from a plurality of constituent elements in the system control unit 10, the bus controller 12 checks the priority levels of the constituent elements, accepts the DMA access request from the constituent element with highest priority level out of all the constituent elements making the DMA access requests, and does not accept the DMA access requests from the other constituent elements. In this manner, the bus controller 12 arbitrates the DMA access requests based on the priority levels of the constituent elements in the system control unit 10.

The image-pickup interface 131 is a processing block for writing (storing) the input image data, which has been input from the imager 30, to the DRAM 20. The image-pickup interface 131 temporarily stores the input image data that has been input from the imager 30. In writing the input image data to the DRAM 20, the image-pickup interface 131 outputs a DMA access request to access the DRAM 20 to the bus controller 12. After the DMA access request is accepted by the bus controller 12, the image-pickup interface 131 outputs the temporarily-stored input image data to the DRAM 20 via the bus controller 12.

The image processing unit 132 is a processing block for reading the input image data stored in the DRAM 20, subjecting the input image data to a variety of image processing operations, and writing (storing) output image data having been processed for display to the DRAM 20. The image processing unit 132 includes: an input DMA unit 133; image processing modules (an image processing module 134-1 to an image processing module 134-3): and an output DMA unit 135. The image processing unit 132 has its constituent elements connected in series, and subjects a plurality of image processing operations to pipeline processing, to thereby actualize a plurality of image processing operations in a narrow bus bandwidth.

The input DMA unit 133 is a processing block for reading the input image data stored in the DRAM 20 and outputting the input image data that has been read to the image processing module 134-1. When reading the input image data from the DRAM 20, the input DMA unit 133 outputs a DMA access request to access the DRAM 20 to the bus controller 12. After the DMA access request is accepted by the bus controller 12, the input DMA unit 133 reads the input image data from the DRAM 20 via the bus controller 12, and temporarily stores the input image data that has been read. The input DMA unit 133 then outputs the temporarily-stored input image data to the image processing module 134-1.

Each of the image processing module 134-1 to the image processing module 134-3 performs a variety of digital image processing operations on the image signals that have been input, and output them to the processing block at its subsequent stage. Examples of the image processing by the image processing module 134-1 to the image processing module 134-3 include image processing for recording which records image signals and image processing for display which displays an image of a subject on the display unit 40. In the following description, it is assumed that the input image data that has been input from the input DMA unit 132 is converted (image-processed) to image signals for display by use of the image processing module 134-1 to the image processing module 134-3, and is then output as output image data from the image processing module 134-3 to the output DMA unit 135.

The output DMA unit 135 is a processing block for writing (storing) the output image data, which has been input from the image processing module 134-3, to the DRAM 20. The output DMA unit 135 temporarily stores the output image data that has been input from the image processing module 134-3. When writing the output image data to the DRAM 20, the output DMA unit 135 outputs a DMA access request to access the DRAM 20 to the bus controller 12. After the DMA access request is accepted by the bus controller 12, the output DMA unit 135 outputs the temporarily-stored output image data to the DRAM 20 via the bus controller 12.

The video interface 136 is a processing block for reading the output image data stored in the DRAM 20 and outputting the output image data that has been read to the display unit 40. When reading the output image data from the DRAM 20, the video interface 136 outputs a DMA access request to access the DRAM 20 to the bus controller 12. After the DMA access request is accepted by the bus controller 12, the video interface 136 reads the output image data from the DRAM 20 via the bus controller 12, and temporarily stores the output image data that has been read. The video interface 136 then outputs the temporarily-stored output image data to the display unit 40.

In this manner, each processing block in the system control unit 10 temporarily stores data in a temporary storage region (buffer) provided therein. After the DMA access request is accepted by the bus controller 12, each processing block writes/reads the temporarily-stored data to/from the DRAM 20 via the data bus 11 and the bus controller 12.

The processing blocks in the system control unit 10 are divided into: processing blocks that read data from the DRAM 20 through the DMA access, such as the video interface 136 and the input DMA unit 133 (hereinafter, each referred to as a “read proxy”); and processing blocks that write data to the DRAM 20 through the DMA access, such as the image-pickup interface 131 and the output DMA unit 135 (hereinafter, each referred to as a write proxy).

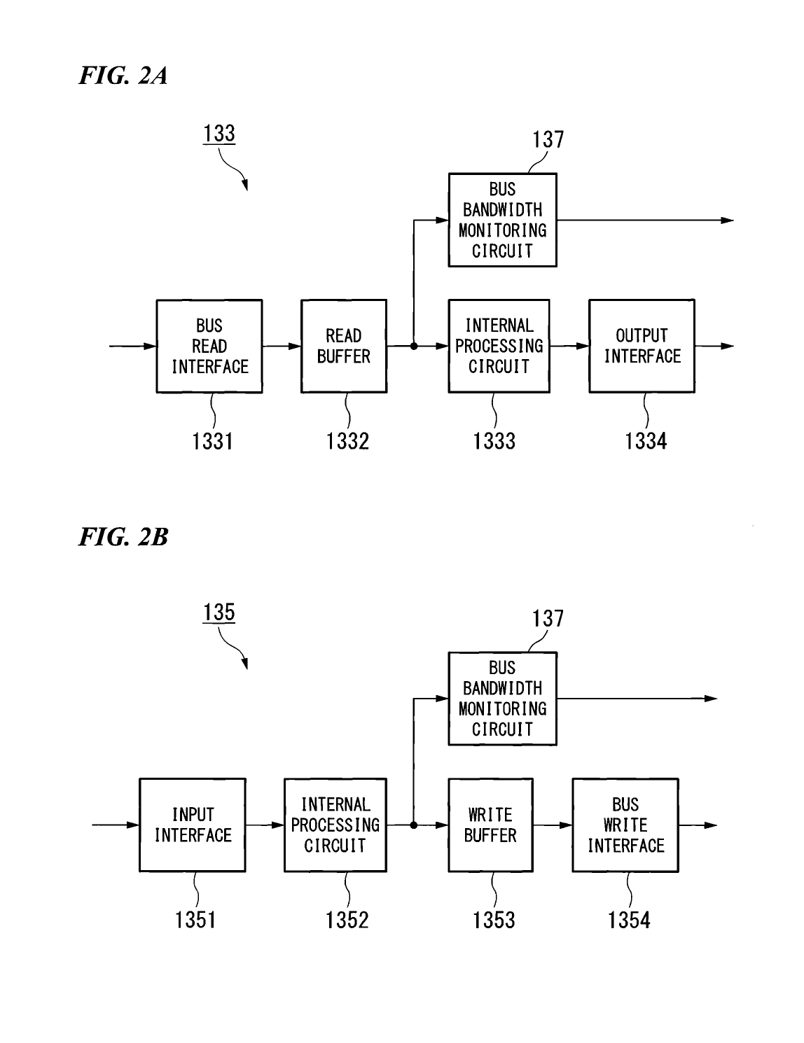

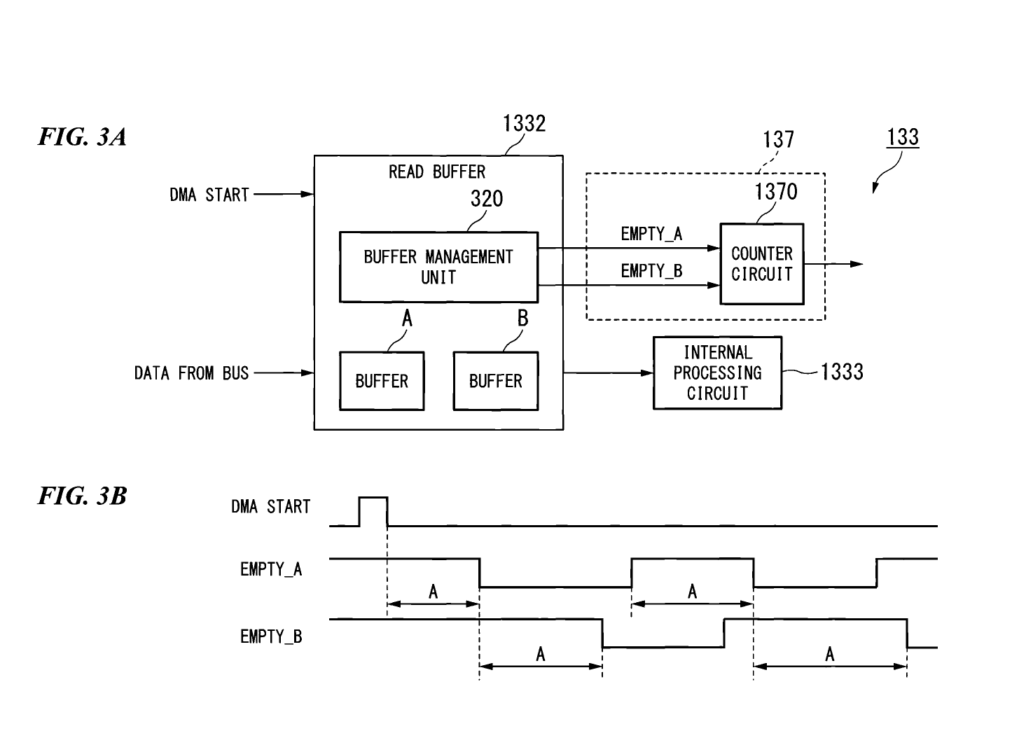

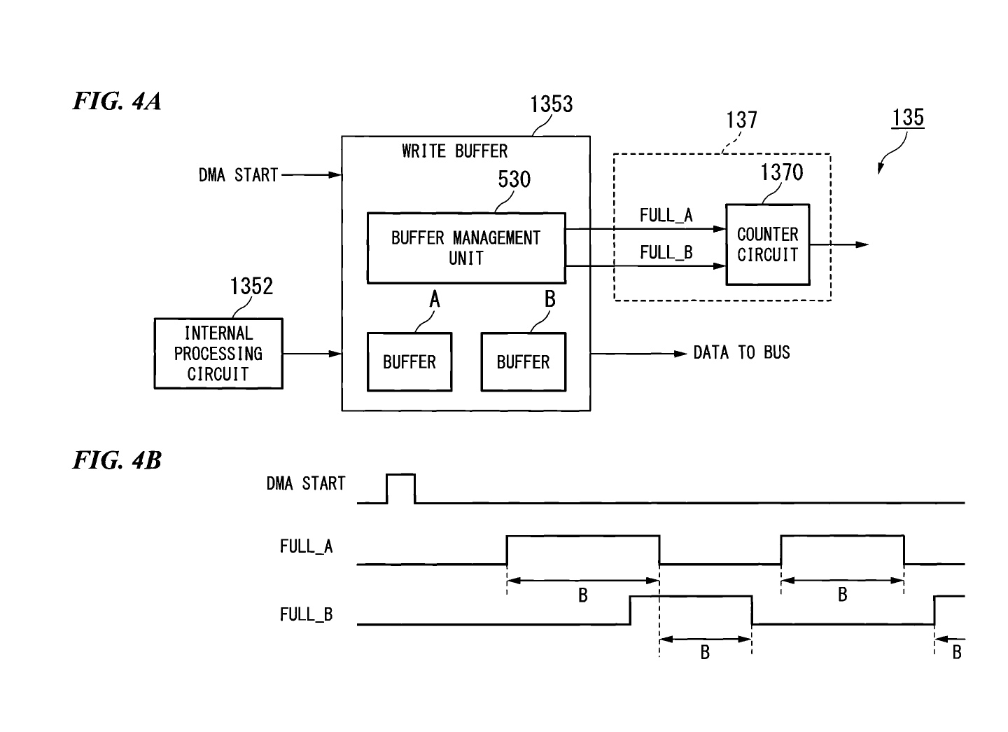

Next, the processing blocks in the system control unit 10 will be described. FIG. 2A and FIG. 2B are block diagrams each showing a schematic configuration of a processing block in accordance with the first preferred embodiment of the present invention. FIG. 2A shows a schematic configuration of a read proxy. FIG. 2B shows a schematic configuration of a write proxy. In the following description, the input DMA unit 133 will be described as a read proxy, and the output DMA unit 135 will be described as a write proxy. Furthermore, the input DMA unit 133 may be referred to as the read proxy 133, and the output DMA unit 135 may be referred to as the write proxy 135.

As shown in FIG. 2A, the read proxy 133 includes: a bus read interface 1331; a read buffer 1332; an internal processing circuit 1333; an output interface 1334; and a bus bandwidth monitoring circuit 137.

The bus read interface 1331 is an interface circuit that takes the data, which is read from the DRAM 20 to the data bus 11 through the DMA access, into the read proxy 133.

The read buffer 1332 is a buffer circuit that temporarily stores the data in the data bus 11 taken in by the bus read interface 1331.

The internal processing circuit 1333 is a processing circuit that processes, as the read proxy 133, the data temporarily-stored in the read buffer 1332.

The output interface 1334 is an interface circuit that outputs the data processed by the internal processing circuit 1333 to another block connected to the read proxy 133 (for example, to the image processing module 134-1 if the read proxy 133 is the input DMA unit 133).

The bus bandwidth monitoring circuit 137 is a monitoring circuit that obtains information functioning as a guideline necessary for setting the priority levels of the read proxy 133 (hereinafter, referred to as “priority guideline information”).

As shown in FIG. 2B, the write proxy 135 includes: an input interface 1351; an internal processing circuit 1352; a write buffer 1353; a bus write interface 1354; and a bus bandwidth monitoring circuit 137.

The input interface 1351 is an interface circuit that inputs the data, which has been input from the other block connected to the write proxy 135 (for example, to the image processing module 134-3 if the write proxy 135 is the output DMA unit 135), to the write proxy 131.

The internal processing circuit 1352 is a processing circuit that processes, as the write proxy 135, the data which has been input via the input interface 1351.

The write buffer 1353 is a buffer circuit that temporarily stores the data processed by the internal processing circuit 1352 for outputting to the DRAM 20 through the DMA access.

The bus write interface 1354 is an interface circuit that outputs the data temporarily stored in the write buffer 1353 to the data bus 11 and writes the data to the DRAM 20.

The bus bandwidth monitoring circuit 137 is a monitoring circuit that obtains the priority guideline information on the write proxy 135.

Next, a configuration in which priority guideline information on each processing block in the system control unit 10 is obtained will be described. FIG. 3A, FIG. 3B, FIG. 4A, and FIG. 4B are diagrams showing a schematic configuration and for explaining a method of obtaining priority guideline information in a processing block in accordance with the first preferred embodiment of the present invention. FIG. 3A and FIG. 3B show the case of the read proxy 133. FIG. 4A and the FIG. 4B show the case of the write proxy 135.

Firstly, the read proxy 133 shown in FIG. 3A and FIG. 3B will be described. FIG. 3A is a block diagram showing a configuration of constituent elements involved in obtaining priority guideline information in the read proxy 133. FIG. 3B is a diagram for explaining a method of obtaining priority guideline information. Note that FIG. 3A shows the case where an amount of data temporarily storable in the processing block is large. Namely, FIG. 3A shows a block diagram for obtaining priority guideline information in the read proxy 133 in which the read buffer 1332 is a large-capacity buffer.

In the system control unit 10, each processing block is connected to the data bus 11. Each processing block shares the data bus 11. The read proxy 133 processes the data that the internal processing circuit 1333 acquires from the DRAM 20 through the data bus 11.

The read buffer 1332 included in the read proxy 133 will be described. As shown in FIG. 3A, the read buffer 1332 includes two buffers (a buffer A and a buffer B) and a buffer management unit 320 that switches the buffers. When the data acquired from the DRAM 20 through the data bus 11 is stored in the buffer, the buffer management unit 320 selects one of the buffer A and the buffer B and makes the selected buffer store the data acquired from the DRAM 20. When the data stored in the buffer is output to the internal processing circuit 1333, the buffer management unit 320 selects one of the buffer A and the buffer B that stores the data and make the selected buffer output the stored data to the internal processing circuit 1333.

The buffer management unit 320 outputs an empty signal that shows whether or not the buffer A and the buffer B store data. The empty_A signal shown in FIG. 3A shows whether or not the buffer A stores data. When all storage areas in the buffer A do not store data, the empty_A signal becomes “high” level. When all storage areas in the buffer A store data, the empty_A signal becomes “low” level. If part of the storage areas in the buffer A stores data, the empty_A signal keeps its former output level.

In the same way, the empty_B signal shows whether or not the buffer B stores data. When all storage areas in the buffer B do not store data, the empty_B signal becomes “high” level. When all storage areas in the buffer B store data, the empty_B signal becomes “low” level. If part of the storage areas in the buffer B stores data, the empty_B signal keeps its former output level.

Operations of the read buffer 1332 will be described by using FIG. 3B. When the DMA operation of the read proxy 133 is started, the buffer management unit 320 confirms that data is not stored in the buffer A, that is, the empty_A signal is in “high” level. Then, the buffer management unit 320 makes the buffer A store data, which is input from the data bus 11 through the bus read interface 1331. If all storage areas in the buffer A store data, then the empty_A signal is made to be in “low” level.

Then, the buffer management unit 320 confirms that data is not stored in the buffer B, that is, the empty_B signal is in “high” level. Then, the buffer management unit 320 makes the buffer B store data, which is input from the data bus 11 through the bus read interface 1331. If all storage areas in the buffer B store data, then the empty_B signal is made to be in “low” level. Then, data is stored in the buffer A. As described above, when the read buffer 1332 stores data, the buffer A and the buffer B is selected alternately and input data is stored.

Data output in the read buffer 1332 will be described. When the empty_A signal becomes “low” level, data stored in the buffer A is output to the internal processing circuit 1333 according to data request from the internal processing circuit 1333. If all data stored in the buffer A is output to the internal processing circuit 1333, then the buffer management unit 320 makes the empty_A signal “high” level. Then, after the empty_B signal becomes “low” level, data stored in the buffer B is output to the internal processing circuit 1333 according to data request from the internal processing circuit 1333. If all data stored in the buffer B is output to the internal processing circuit 1333, then the buffer management unit 320 makes the empty_B signal “high” level. Then, data stored in the buffer A is output. As described above, when the read buffer 1332 outputs data, the buffer A and the buffer B is selected alternately and data stored in the selected buffer is output.

As is described above, in the system control unit 10, each processing block is connected to the common data bus 11. After data acquired from the DRAM 20 through the data bus 11 is stored in the read buffer 1332 temporally, the internal processing circuit 1333 processes the data stored in the read buffer 1332. The read proxy 133 acquires data from the DRAM 20 by the DMA access. The read buffer 1332 included in the read proxy 133 has large capacity, and operates two buffers alternately as described above. For example, if the DMA access request output from the read proxy 133 is received by the bus controller 12 and the DMA access by the read proxy 133 is started once, then the DMA access request from other processing block is not received until data is stored in the two buffers. Thereby, the read proxy 133 occupies the data bus 11. In some cases of a process by the internal processing circuit 1333, it is not necessary that the read proxy 133 occupies the data bus 11, that is, needed data only has to be prepared by the timing when the data is processed by the internal processing circuit 1333. Thereby, the bus bandwidth monitoring circuit 137 measures the time when data from the data bus 11 is stored in each buffer after the DMA operation by the read proxy 133 is started.

As shown in FIG. 3A, the bus bandwidth monitoring circuit 137 measures (counts) the time (clock cycle number) when data from the data bus 11 is stored in the buffer A and the buffer B based on the empty_A signal and the empty_B signal output from the buffer management unit 320.

The bus bandwidth monitoring circuit 137 counts the time when data is stored in the buffer A or the buffer B in the read buffer 1332 after the DMA operation by the read proxy 133 is started. More specifically, as shown in FIG. 3B, the bus bandwidth monitoring circuit 137 counts the clock cycle number of the counted term A when the empty_A signal or the empty_B signal is in “high” level. Then, the clock cycle number of the counted term A is output as the priority guideline information.

The write proxy 135 shown in FIGS. 4A and 4B will be described. FIG. 4A is a diagram showing a schematic configuration for obtaining priority guideline information in the write proxy 135. FIG. 4B is a diagram showing a schematic configuration for explaining a method of obtaining priority guideline information. FIG. 4A shows the write proxy 135, in which the amount of data that can be temporally stored in the processing block is large, that is, the write buffer 1353 has a large-capacity.

In the system control unit 10, each processing block is connected to the data bus 11. Each processing block shares the data bus 11. The write proxy 135 writes the data, which has been processed by the internal processing circuit 1352, to the DRAM 20 through the data bus 11.

The write buffer 1353 included in the write proxy 135 will be described. As shown in FIG. 4A, the write buffer 1353 includes two buffers (a buffer A and a buffer B) and a buffer management unit 530 that switches the buffers. When the data that has been processed by the internal processing circuit 1352 to the DRAM 20 through the data bus 11 is stored in the buffer, the buffer management unit 530 selects one of the buffer A and the buffer B and makes the selected buffer store the data that has been processed by the internal processing circuit 1352. When the data stored in the buffer is output to the DRAM 20, the buffer management unit 530 selects one of the buffer A and the buffer B that stores the data and make the selected buffer output the stored data to the DRAM 20 through the data bus 11.

The buffer management unit 530 outputs a full signal that shows whether or not the buffer A and the buffer B store data. The full_A signal shown in FIG. 4A shows whether or not the buffer A stores data. When all storage areas in the buffer A store data, the full_A signal becomes “high” level. When all storage areas in the buffer A do not store data, the full_A signal becomes “low” level. If part of the storage areas in the buffer A stores data, the full_A signal keeps its former output level.

In the same way, the full_B signal shows whether or not the buffer B stores data. When all storage areas in the buffer B store data, the full_B signal becomes “high” level. When all storage areas in the buffer B do not store data, the full_B signal becomes “low” level. If part of the storage areas in the buffer B stores data, the full_B signal keeps its former output level.

Operations of the write buffer 1353 will be described by using FIG. 4B. When the DMA operation of the write proxy 135 is started, the buffer management unit 530 confirms that data is not stored in the buffer A, that is, the full_A signal is in “low” level. Then, the buffer management unit 530 makes the buffer A store data, which has been processed by the internal processing circuit 1352. If all storage areas in the buffer A store data, then the full_A signal is made to be in “high” level.

Then, the buffer management unit 530 confirms that data is not stored in the buffer B, that is, the full_B signal is in “low” level. Then, the buffer management unit 530 makes the buffer B store data, which has been processed by the internal processing circuit 1352. If all storage areas in the buffer B store data, then the full_B signal is made to be in “high” level. Then, data is stored in the buffer A. As described above, when the write buffer 1353 stores data, the buffer A and the buffer B is selected alternately and data processed by the internal processing circuit 1352 is stored.

Data output in the write buffer 1353 will be described. When the full_A signal becomes “high” level, data stored in the buffer A is output to the data bus 11 through the bus write interface 1354 according to data request from the bus write interface 1354. If all data stored in the buffer A is output to the data bus 11 through the bus write interface 1354, then the buffer management unit 530 makes the full_A signal “low” level. Then, after the full_B signal becomes “high” level, data stored in the buffer B is output to the data bus 11 through the bus write interface 1354 according to data request from the bus write interface 1354. If all data stored in the buffer B is output to the data bus 11 through the bus write interface 1354, then the buffer management unit 530 makes the full_B signal “low” level. Then, data stored in the buffer A is output. As described above, when the write buffer 1353 outputs data, the buffer A and the buffer B is selected alternately and data stored in the selected buffer is output to the data bus 11 through the bus write interface 1354.

As is described above, in the system control unit 10, each processing block is connected to the common data bus 11. After data processed by the internal processing circuit 1352 is stored in the write buffer 1353 temporally, the write proxy 135 writes the data stored in the write buffer 1353 to the DRAM 20 through the data bus 11. The write proxy 135 writes data to the DRAM 20 by the DMA access. The write buffer 1353 included in the write proxy 135 has large capacity, and operates two buffers alternately as described above. For example, if the DMA access request output from the write proxy 135 is received by the bus controller 12 and the DMA access by the write proxy 135 is started once, then the DMA access request from other processing block is not received until data is stored in the two buffers. Thereby, the write proxy 135 occupies the data bus 11. In some cases of a process by the internal processing circuit 1352 in the write proxy 135, it is not necessary that the write proxy 135 occupies the data bus 11, that is, data only has to be written to the DRAM 20 after data processed by the internal processing circuit 1352 is prepared. Thereby, the bus bandwidth monitoring circuit 137 measures the time when data is output from each buffer to the data bus 11 after the DMA operation by the write proxy 135 is started.

As shown in FIG. 4A, the bus bandwidth monitoring circuit 137 measures (counts) the time (clock cycle number) when data is output to the data bus 11 from the buffer A and the buffer B based on the full_A signal and the full_B signal output from the buffer management unit 530.

The bus bandwidth monitoring circuit 137 counts the time when data is stored in the buffer A or the buffer B in the write buffer 1353, that is the time when stored data is output to the data bus 11, after the DMA operation by the write proxy 135 is started. More specifically, as shown in FIG. 4B, the bus bandwidth monitoring circuit 137 counts the clock cycle number of the counted term B when the full_A signal or the full_B signal is in “high” level. Then, the clock cycle number of the counted term B is output as the priority guideline information.

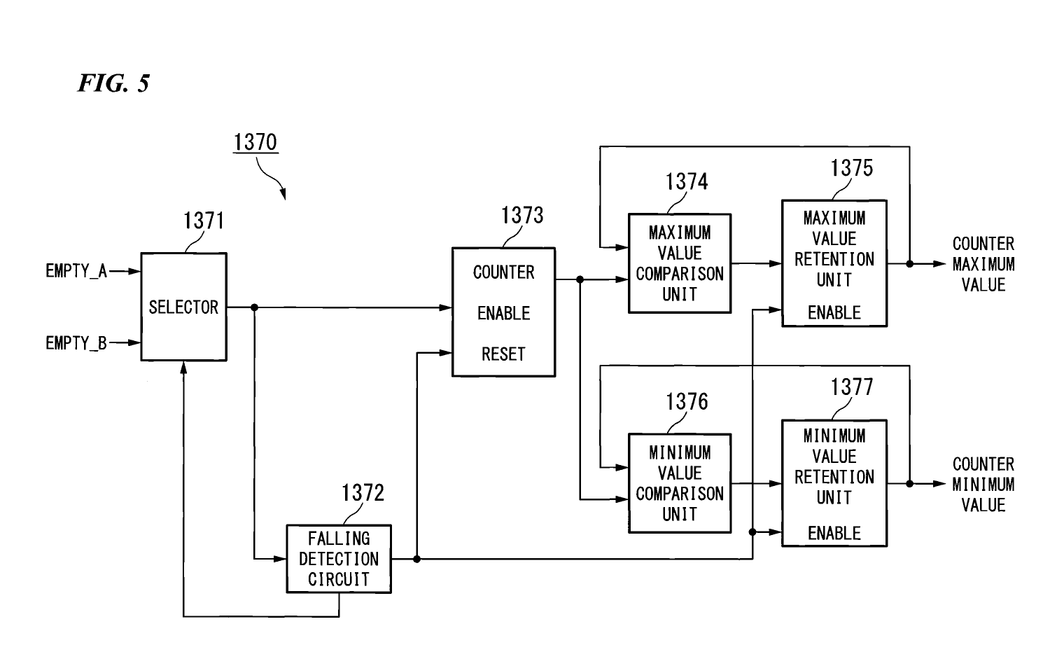

Next, the bus bandwidth monitoring circuit 137 will be described in further detail. FIG. 5 is a block diagram showing a configuration of the bus bandwidth monitoring circuit 137 in the processing blocks in accordance with the first preferred embodiment of the present invention. FIG. 5 is a block diagram showing a detailed configuration of the counter circuit 1370 shown in FIG. 3A and FIG. 4A. The counter circuit 1370 shown in FIG. 5 includes: a selector 1371; a falling detection circuit 1372; a counter 1373; a maximum value comparison unit 1374; a maximum value retention unit 1375; a minimum value comparison unit 1376; and a minimum value retention unit 1377. In the following description, the bus bandwidth monitoring circuit 137 included in the read proxy 133 that is the input DMA unit 133 will be described.

The selector 1371 selects one of the empty_A signal and the empty_B signal output from the buffer management unit 320 in the read buffer 1332 as an enable signal that represents the term that the counter 1373 counts. The selection of the empty_A signal and the empty_B signal by the selector 1371 is performed by a selection signal output from the falling detection circuit 1372.

The counter 1373 counts the operation clock number (clock cycle number) of the process block at the term when the enable signal (the empty_A signal and the empty_B signal) output from the selector 1371 is in “high” level. Thereby, the counter 1373 counts the time when data from the data bus 11 is stored in the buffer A or the buffer B. If the reset signal is input from the falling detection circuit 1372, the counter 1373 initializes (resets) the counting value (count value).

The falling detection circuit 1372 detects the timing when the enable signal output from the selector 1371 falls down (the timing when the enable signal changes from “high” level to “low” level), that is the timing when all data is stored in the storage area of the buffer A and the buffer B. Then, the falling detection circuit 1372 outputs the reset signal that resets the counter 1373 at the timing when the enable signal falls down. The falling detection circuit 1372 outputs the selection signal to the selector 1371 at the same timing as the output of the reset signal. The selector 1371 selects one of the empty_A signal and the empty_B signal based on the selection signal. For example, if the empty_A signal is selected as the enable signal, the selection signal is output at the timing when the enable signal (empty_A signal) falls down. Thereby, the selector 1371 switches the enable signal to the empty_B signal.

The maximum value comparison unit 1374 compares the count value currently counted by the counter 1373 and the count value retained in the maximum value retention unit 1375, and outputs the greater of the two values to the maximum value retention unit 1375.

The maximum value retention unit 1375 retains, as a counter maximum value, the count value that is input from the maximum value comparison unit 1374 at the timing when the falling detection circuit 1372 outputs the reset signal, namely, at the timing when all data is stored in the storage area of the buffer A or the buffer B. The counter maximum value retained by the maximum value retention unit 1375 is used as a piece of information included in the priority guideline information to be obtained by the bus bandwidth monitoring circuit 137.

The minimum value comparison unit 1376 compares the count value, which is counted currently by the counter 1373, with the count value stored in the minimum value retention unit 1377. Then, the minimum value comparison unit 1376 outputs the smaller count value to the minimum value retention unit 1377.

The minimum value retention unit 1377 retains, as a counter minimum value, the count value that is input from the minimum value comparison unit 1376 at the timing when the falling detection circuit 1372 outputs the reset signal, namely, at the timing when all data is stored in the storage area of the buffer A or the buffer B. The counter minimum value retained by the minimum value retention unit 1377 is used as a piece of information included in the priority guideline information to be obtained by the bus bandwidth monitoring circuit 137.

As described above, in the example shown in FIG. 5, the maximum time and the minimum time when data read from the DRAM 20 is stored in the read buffer 1332 can be acquired as the priority guideline information in the process of the read proxy 133 by the bus bandwidth monitoring circuit 137 included in the processing block. Then, the priority of the processing block can be set based on the priority guideline information that is acquired.

In the configuration of the bus bandwidth monitoring circuit 137 shown in FIG. 5, the buffer A and the buffer B are not distinguished each other, and the maximum time and the minimum time when data is stored in the read buffer 1332 are acquired as the priority guideline information. For example, in another configuration, the buffer A and the buffer B in the read buffer 1332 may be distinguished each other, and the maximum time and the minimum time in each buffer may be acquired as the priority guideline information.

In FIG. 5, the example of the bus bandwidth monitoring circuit 137 included in the read proxy 133 that is the input DMA unit 133 was described. The bus bandwidth monitoring circuit 137 included in the write proxy 135 that is the output DMA unit 135 can be described by replacing the empty_A signal and the empty_B signal in FIG. 5 with the full_A signal and the full_B signal.

Next, a method of setting the priority levels of each processing block in the system control unit 10 based on the priority guideline information will be described. In the image processing device 1, the priority levels of each processing block is set according to the importance level for operation of each processing block in each operation mode of the image processing device 1. In the following description, it is supposed that the bus controller 12 in the system control unit 10 sets priority levels in the system control unit 10 based on the priority guideline information which is output from each processing block, and arbitrates the DMA access requests from the processing blocks.

The importance levels for operation of each processing block in each operation mode of the image processing device 1 are, for example, divided as follows, and the priority levels are set according to the importance level of their operation based on the following concept. The bus controller 12 knows beforehand the processing time when the internal processing circuit of each processing block performs the process based on data stored in the buffer A or the buffer B. Thereby, the bus controller 12 recognizes the allowance storage time when data is stored in one buffer in the processing block or the allowance output time when data stored in one buffer is output as the allowance time in the processing block. Then, the bus controller 12 sets the priority based on the priority guideline information.

### (Importance Level 1)

For example, the image-pickup interface 131 and the video interface 136 are processing blocks with highest priority level in the image processing device 1. Therefore, their priority levels are required to be set high. At this time, the bus controller 12 sets the priority levels so that there is little difference between the counter maximum value and the counter minimum value of the priority guideline information output from the image-pickup interface 131 and the video interface 136 and the processing time of the processing block calculated based on the counter maximum value and the counter minimum value is under the allowance time of the processing block including a predetermined margin. The calculation of the processing time of the processing block based on the counter maximum value is performed, for example, by multiplying the counter maximum value and the operation clock of the processing block. Also, in the same way, the processing time of the processing block based on the counter minimum value can be calculated by multiplying the counter minimum value and the operation clock of the processing block. As described above, by reducing the difference between the counter maximum value and the counter minimum value, the DMA access request by the processing block is equalized (dispersed) and the process of the processing block is finished within the permissible processing time. If a plurality of processing blocks in which the same priority is set exist, then the above described condition may be satisfied and the setting of the priority may be lessened. This is to prevent the DMA accesses by the processing blocks with the highest importance level from occupying the data bus 11.

### (Importance Level 2)

A processing block in the image processing device 1 which does not have the highest priority level but whose processing time to the completion of processing (permissible processing time) is predetermined is required to complete the processing within the permissible processing time. At this time, the bus controller 12 calculates the processing time of the processing block based on the counter maximum value of the priority guideline information, and sets the priority level so that the processing by the processing block will be completed within the predetermined permissible processing time. The processing time of the processing block based on the counter maximum value can be calculated in the same way as the above described calculation method. If the calculated processing time is not shorter than the permissible processing time, then the bus controller 12 sets the priority level of the processing block high. If the calculated processing time is not longer than the permissible processing time, then the bus controller 12 sets the level of priority of the processing block low. The priority level of a processing block is set so that the time in which predetermined margin is included in the processing time of the relevant processing block is equal to the permissible processing time. This makes it possible to prevent the priority level of the processing block from being set higher than necessary.

### (Importance Level 3)

For a processing block in the image processing device 1 whose importance level is low and whose permissible processing time is not determined, the initially-set priority level is not particularly changed. However, if the priority level turns out to be higher than that of the processing block with importance level 1 or importance level 2, for example the priority level may be set lower than that of the processing block with importance level 1 or importance level 2.

As described above, the priority level of each processing block in the system control unit 10 is set based on a piece of priority guideline information obtained by the bus bandwidth monitoring circuit 137 that is included in the processing block. Thereby, the priority levels of the processing blocks can be set so that a failure as a system will not be caused in each operation mode of the image processing device 1. Note that the priority level of each processing block in the system control unit 10 may be set based on plural pieces of priority guideline information that distinguishes the buffer A and the buffer B and is obtained by the bus bandwidth monitoring circuits 137 that are included in the processing block.

In the description of the method of setting the priority levels of the processing blocks, the bus controller 12 in the system control unit 10 sets the priority levels and arbitrates the DMA access requests. However, the method is not limited to this. For example, a control unit (not shown in the figure) in the system control unit 10 or a control unit (not shown in the figure) for the whole of the image processing device 1 may set the priority levels of the processing blocks in the system control unit 10, and the bus controller 12 in the system control unit 10 may arbitrate the DMA access requests based on the priority levels that have been set.

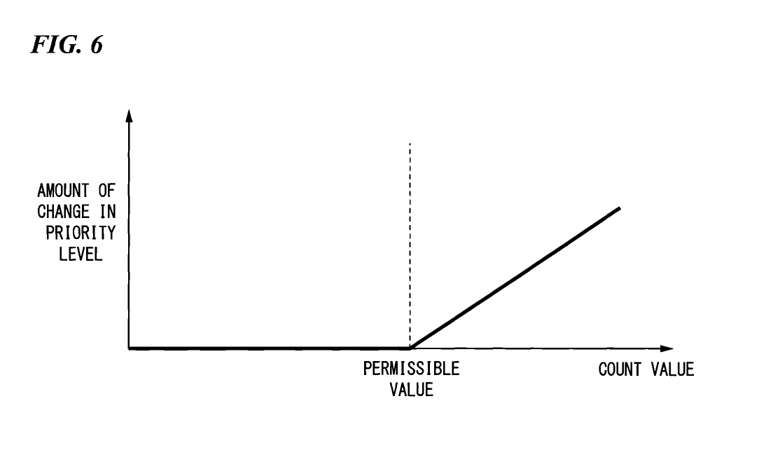

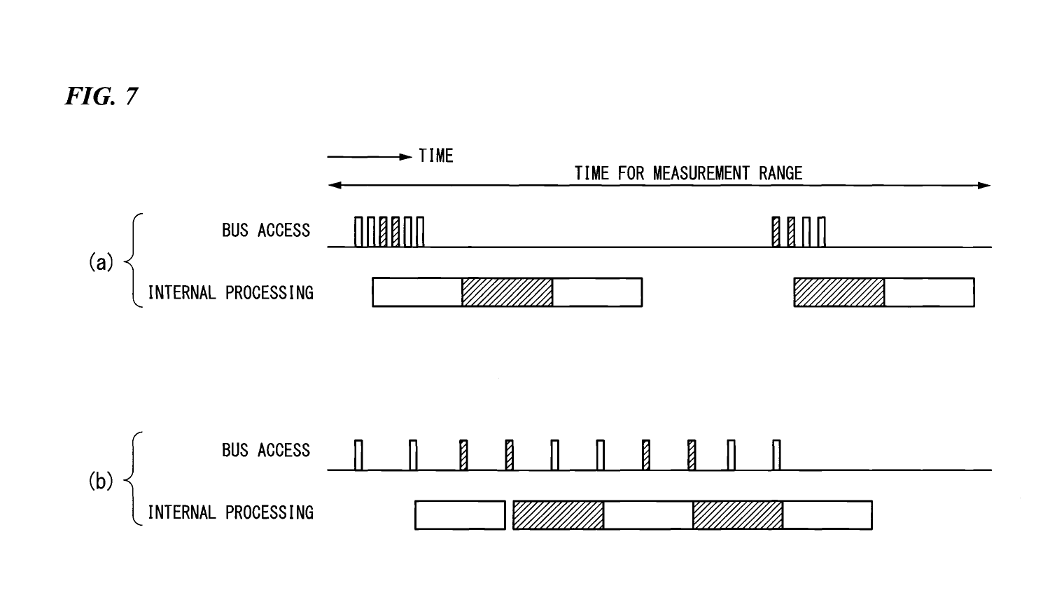

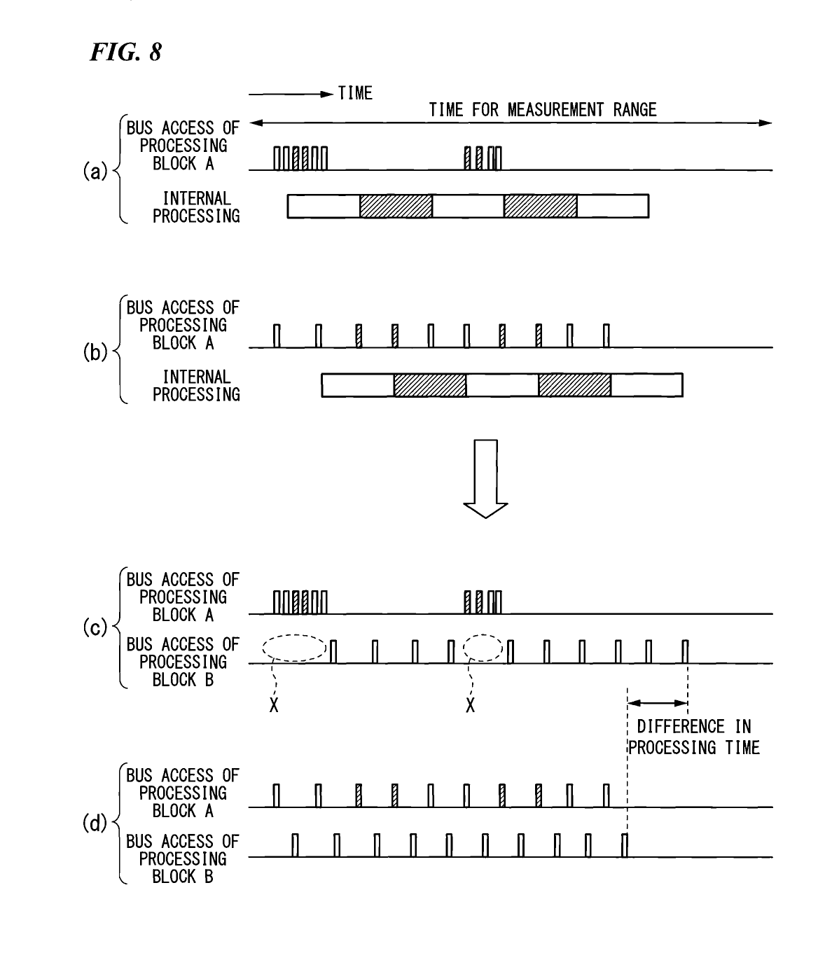

If the priority level in each processing block in the system control unit 10 is dynamically changed, for example the amount by which the priority level is changed can be modified based on the priority guideline information. FIG. 6 is a diagram for explaining an example of modifying the amount of change by which the priority level of a processing block is changed according to the result (priority guideline information) obtained by the bus bandwidth monitoring circuit in accordance with the first preferred embodiment of the present invention. FIG. 6 shows the case in which the priority level of the processing block that changes the priority based on the counter maximum value and which importance level is 2 in the priority guideline information is changed dynamically.

In the example shown in FIG. 6, if the counter maximum value as the priority guideline information is not greater than the predetermined permissible value, the priority level of the relevant processing block is not changed. If the counter maximum value is greater than the predetermined permissible value, the amount of change for the priority level is made larger. With such control, for example if the latency of the internal processing circuit in a specified processing block is longer than the permissible value, the amount of change for setting the priority level high can be modified according to the latency of the internal processing circuit. As a result, even in a processing block in which the probability of acceptance of DMA access requests by the bus controller 12 is low, it is possible to increase the probability of acceptance of the DMA access requests.

As described above, according to the preferred embodiment of the present invention, a bus bandwidth monitoring circuit is included in each processing block. Thereby, the time when data from the data bus is stored in the buffer or data stored in the buffer is output to the data bus can be acquired as the priority guideline information. Based on the priority guideline information that is acquired by each processing block, the priority of each block can be adjusted as the DMA access request from each processing block is equalized, for example. Also, for example, in the range where the processing efficiency of each processing block is not reduced, the priority of each processing block can be adjusted so that the bus bandwidth of the data bus is not suppressed and the priority guideline information comes close to the permissible value.

As described above, according to the preferred embodiment of the present invention, the priority levels of the processing blocks can be efficiently set. As a result, it is possible to find the settings of the levels of priority that do not cause a failure as a system at an early stage, improving the efficiency in system development.

In the preferred embodiment of the present invention, the description has been for the case of a configuration in which, as the priority guideline information obtained by the bus bandwidth monitoring circuit 137, the counter maximum value and the counter minimum value are obtained as shown in FIG. 5. However, as priority guideline information, other information may be obtained. For example, by obtaining a plurality of count value of the counter 1373 shown in FIG. 5, it is also possible to confirm the time when the buffer stores data in the current priority setting or the variance of the bus bandwidth based on the time variance of the data output from the buffer. Furthermore, for example, the number of times that the counter maximum value not less than a predetermined value and the number of times that the counter minimum value not greater than the predetermined value may be obtained. The results can be utilized as information useful for system development such as whether the change in the settings of the priority levels has made the processing time of the processing block shorter or longer.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. A bus bandwidth monitoring device comprising:
a buffer unit that is connected to a common bus, the buffer unit storing data that has been input via the common bus;
a processing unit that performs predetermined processing based on the data stored in the buffer unit; and
a detection unit that detects a bandwidth of the data of the common bus based on a state of storage of the data that is input to the buffer unit through the common bus.

2. A bus bandwidth monitoring device comprising:
a processing unit that performs predetermined processing on input data and outputs the processed data;
a buffer unit that is connected to a common bus, the buffer unit storing the data that has been output by the processing unit and outputting the stored data to the common bus; and
a detection unit that detects a bandwidth of the data on the common bus based on a state of reading of the data that is output to the common bus from the buffer unit.

3. The bus bandwidth monitoring device according to claim 1,
wherein the detection unit comprises:
a counter unit that measures a period of time between a time when the data is input to the buffer unit from the common bus and a time when the data is stored in all storage area of the buffer unit, and
wherein information on the period of time measured by the counter unit is output as information on the bandwidth of the data on the common bus.

4. The bus bandwidth monitoring device according to claim 2,
wherein the detection unit comprises:
a counter unit that measures a period of time between a time when the data stored in the buffer unit is output through the common bus and a time when the data is read out from all storage area of the buffer unit, and
wherein information on the period of time measured by the counter unit is output as information on the bandwidth of the data on the common bus.

5. The bus bandwidth monitoring device according to claim 3,
wherein the detection unit comprises:
a maximum value storage unit that stores information of a maximum period on the periods of time measured by the counter unit; and
a minimum value storage unit that stores information of a minimum period on the periods of time measured by the counter unit, and
wherein the information of a maximum period stored in the maximum value storage unit and the information of a minimum period stored in the minimum value storage unit are output as pieces of information on the bandwidth of the data on the common bus.

6. The bus bandwidth monitoring device according to claim 4,
wherein the detection unit comprises:
a maximum value storage unit that stores information of a maximum period on the periods of time measured by the counter unit; and
a minimum value storage unit that stores information of a minimum period on the periods of time measured by the counter unit, and
wherein the information of a maximum period stored in the maximum value storage unit and the information of a minimum period stored in the minimum value storage unit are output as pieces of information on the bandwidth of the data on the common bus.

7. The bus bandwidth monitoring device according to claim 5, wherein
the buffer unit comprises a plurality of buffer circuits each of which stores the data,
the detection unit switches the plurality of buffer circuits,
the counter unit measures the periods of time of each of the plurality of buffer circuits,
the maximum value storage unit stores information on a maximum period of time out of the periods of time measured by the counter unit,
the minimum value storage unit stores information on a minimum period of time out of the periods of time measured by the counter unit, and
the detection unit outputs the information on the maximum period of time stored in the maximum value storage unit and the information on the minimum period of time stored in the minimum value storage unit as information on bandwidth of the data on the common bus.

8. The bus bandwidth monitoring device according to claim 6, wherein
the buffer unit comprises a plurality of buffer circuits each of which stores the data,
the detection unit switches the plurality of buffer circuits,
the counter unit measures the periods of time of each of the plurality of buffer circuits,
the maximum value storage unit stores information on a maximum period of time out of the periods of time measured by the counter unit,
the minimum value storage unit stores information on a minimum period of time out of the periods of time measured by the counter unit, and
the detection unit outputs the information on the maximum period of time stored in the maximum value storage unit and the information on the minimum period of time stored in the minimum value storage unit as information on bandwidth of the data on the common bus.

9. The bus bandwidth monitoring device according to claim 5, wherein
the buffer unit comprises a plurality of buffer circuits each of which stores the data,
the counter unit measures the periods of time of each of the plurality of buffer circuits respectively,
the maximum value storage unit stores information on a maximum period of time out of the periods of time measured by the counter unit respectively,
the minimum value storage unit stores information on a minimum period of time out of the periods of time measured by the counter unit respectively, and
the detection unit outputs each of the information on the maximum period of time stored in the maximum value storage unit and each of the information on the minimum period of time stored in the minimum value storage unit related to the plurality of buffer circuits as information on bandwidth of the data on the common bus.

10. The bus bandwidth monitoring device according to claim 6, wherein
the buffer unit comprises a plurality of buffer circuits each of which stores the data,
the counter unit measures the periods of time of each of the plurality of buffer circuits respectively,
the maximum value storage unit stores information on a maximum period of time out of the periods of time measured by the counter unit respectively,
the minimum value storage unit stores information on a minimum period of time out of the periods of time measured by the counter unit respectively, and
the detection unit outputs each of the information on the maximum period of time stored in the maximum value storage unit and each of the information on the minimum period of time stored in the minimum value storage unit related to the plurality of buffer circuits as information on bandwidth of the data on the common bus.

11. A bus bandwidth monitoring method comprising steps of:
storing data that is input through a common bus;
performing predetermined processing based on the stored data; and
detecting a bandwidth of data on the common bus based on a state of storage of the data input through the common bus.

12. A bus bandwidth monitoring method comprising steps of:
performing predetermined processing on input data and outputting the processed data;
receiving and storing the output data via a common bus;
outputting the stored data to the common bus; and
detecting a bandwidth of data on the common bus based on a state of reading of the data output to the common bus.
